(19) United States
(12) Patent Application Publication
(10) Pub. No.: US 2015/0091338 A1
(43) Pub. Date: Apr. 2, 2015

(54) CONVEYANCE SEAT

(71) Applicants: TOYOTA BOSHOKU KABUSHIKI KAISHA, Aichi-ken (JP); SHIROKI CORPORATION, Kanagawa (JP)

(72) Inventor: Hiroaki HAYASHI, Oobu-shi (JP)

(73) Assignees: TOYOTA BOSHOKU KABUSHIKI KAISHA, Aichi-ken (JP); SHIROKI CORPORATION, Kanagawa (JP)

(21) Appl. No.: 14/495,091

(22) Filed: Sep. 24, 2014

(30) Foreign Application Priority Data
Sep. 30, 2013 (JP) 2013-203650

(51) Int. Cl. B60N 2/56; B60N 2/44; B60N 2/68

(52) U.S. Cl. CPC B60N 2/5621; B60N 2/68; B60N 2/4435
USPC 297/180.1; 297/452.18; 297/313

(57) ABSTRACT

A conveyance seat includes: a seat frame; and an attachment device attached to the seat frame. The seat frame includes two members rotating relative to each other around their respective shafts parallel to each other, and respective connecting structures configured to connect the attachment device to one of the two members and to the other of the two members in such a manner that the attachment device is rotated in conjunction with the relative rotation between the two members.

### INCORPORATION BY REFERENCE

The disclosure of Japanese Patent Application No. 2013-203650 filed on Sep. 30, 2013 including the specification, drawings and abstract is incorporated herein by reference in its entirety.

### BACKGROUND OF THE INVENTION

1. Field of the Invention

The present invention relates to a conveyance seat. More particularly, the present invention relates to a conveyance seat including a seat frame and an attachment device attached to the seat frame.

2. Description of Related Art

As a vehicle seat, there has been described a configuration in which an air-conditioning device is attached to a support spring provided in a seatback in a tensioned state (Japanese Patent Application Publication No. 2005-34345 (JP 2005-34345 A)).

### SUMMARY OF THE INVENTION

However, in a case where the seatback is a center-foldable type or the like in which part of a seat frame relatively rotates thereto, it is difficult to attach an attachment device such as an air-conditioning device between these relatively rotatable members in such a manner that the attachment device follows these members appropriately. The present invention provides a conveyance seat in which an attachment device such as an air-conditioning device is attachable between relatively rotatable members of a seat frame in such a manner that the attachment device follows these members appropriately.

A conveyance seat according to an aspect of the present invention includes: a seat frame; and an attachment device attached to the seat frame. The seat frame includes two members rotating relative to each other around their respective shafts parallel to each other, and respective connecting structures configured to connect the attachment device to one of the two members and to the other of the two members in such a manner that the attachment device is rotated in conjunction with the relative rotation between the two members.

According to the above aspect, it is possible to move the attachment device appropriately in conjunction with the relative rotation between the two members. Thus, it is possible to attach the attachment device between the two relatively rotatable members of the seat frame, appropriately in conjunction therewith.

In the above aspect, the two members may be configured such that a radial distance therebetween is changed due to their relative rotation, and at least one of the connecting structures may be provided with a relief structure that is able to relieve that radial displacement of a connection position which is caused due to the relative rotation between the two members.

According to the above configuration, with the use of the relief structure, it is possible to move the attachment device appropriately in conjunction with the relative rotation between the two members while relieving that radial displacement of the connecting position which is caused due to the relative rotation.

In the above configuration, the attachment device may be hooked to the one of the two members with the relief structure that is rotatable and radially slidable, while the attachment device is attached to the other of the two members in a rotatable manner.

According to the above configuration, with a simple configuration in which the attachment device is hooked to the one of the two members and is also attached to the other of the two members in a rotatable manner, it is possible to attach the attachment device between the relatively rotatable members of the seat frame, appropriately in conjunction therewith.

In the above configuration, the other of the two members may be a circular pipe-shaped rod provided across both side frames of a seat cushion; the one of the two members may be a front panel provided across the both side frames so as to be pivotally mounted thereto in a rotatable manner in a height direction; and the attachment device may be a ventilator hooked to a bracket provided in a bottom portion of the front panel so as to be rotatable and slidable in a front-rear direction, and fitted into the rod from an outer peripheral side thereof in a rotatable manner.

According to the above configuration, with the use of a structure to fit the ventilator into the circular pipe-shaped rod from its outer peripheral side, and a structure to hook the ventilator to the bracket provided in a bottom portion of the front panel, it is possible to easily assemble the ventilator so as not to disturb a tilting operation of the front panel of the seat cushion (appropriately in conjunction with the tilting operation).

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view illustrating a schematic configuration of a conveyance seat according to Embodiment 1;

FIG. 2 is a perspective view of a frame structure of a seat cushion when viewed from behind;

FIG. 3 is an exploded perspective view in which a tilt panel and a ventilator are removed;

FIG. 4 is a sectional view taken along a line IV-IV in FIG. 1 and illustrates a state where the seat cushion is tilted down;

FIG. 5 is a sectional view taken along the line IV-IV in FIG. 1 and illustrates a state where the seat cushion is tilted up; and

FIG. 6 is an enlarged schematic view of an essential part in FIGS. 4 to 5.

### DETAILED DESCRIPTION OF EMBODIMENTS

A mode for carrying out the invention will be described below with reference to the drawings.

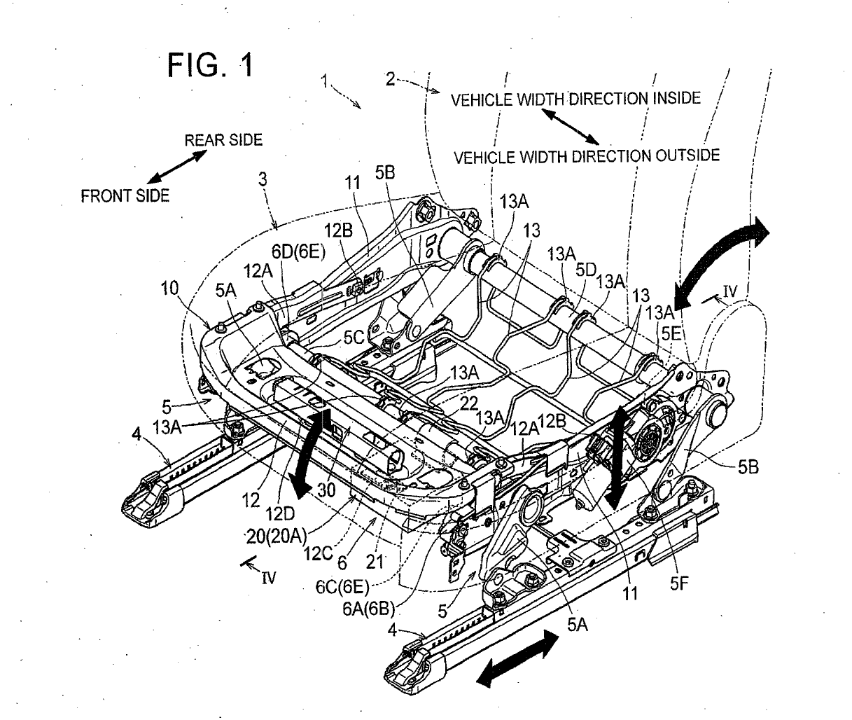

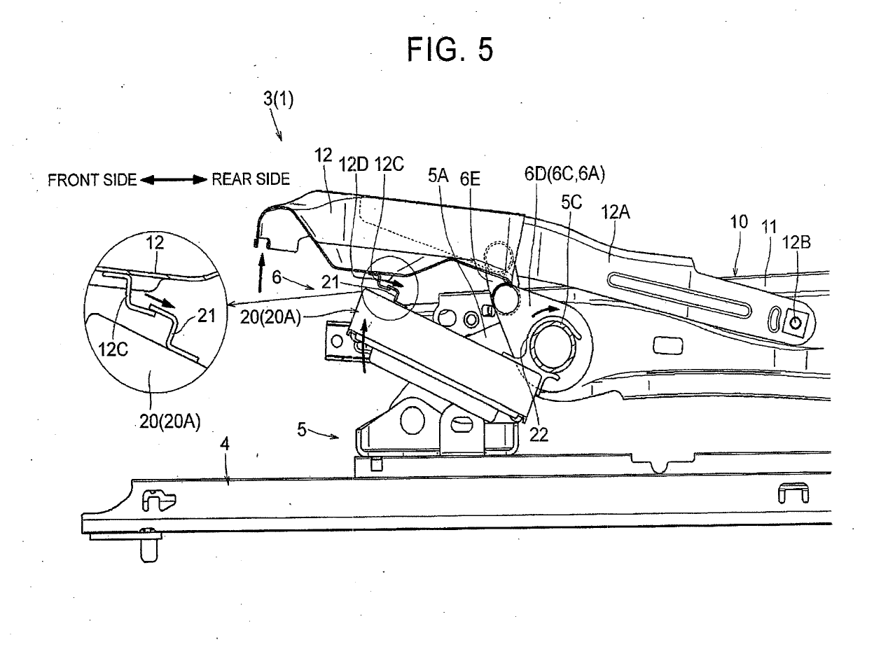

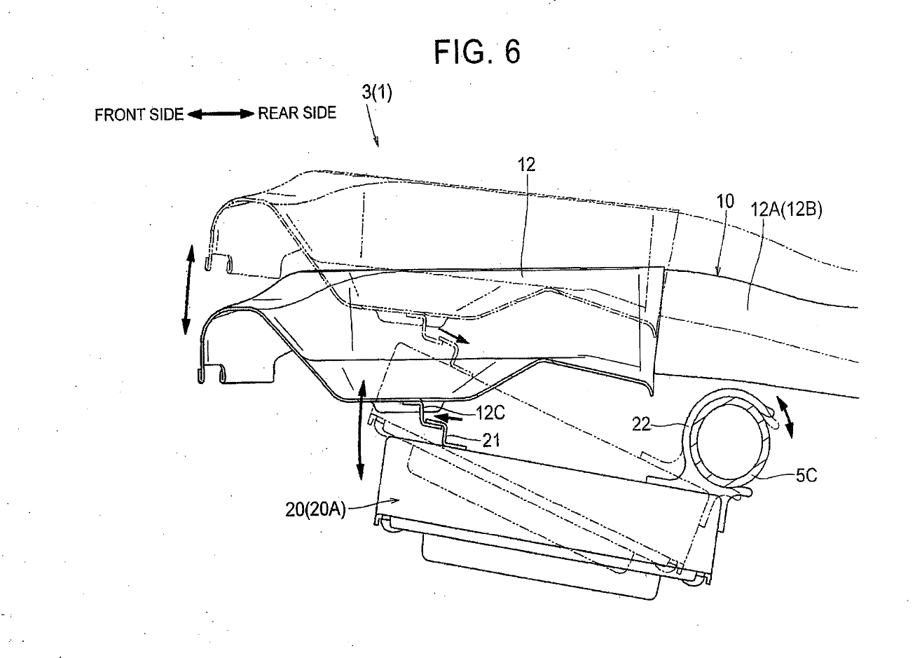

Initially described is a configuration of a seat 1 (a conveyance seat) of Embodiment 1 with reference to FIGS. 1 to 6. The seat 1 of the present embodiment is provided as a front left seat of an automobile, and includes a seatback 2 serving as a backrest for a sitting occupant, and a seat cushion 3 serving as a seat portion, as illustrated in FIG. 1. The seat 1 has a configuration of a so-called “power seat,” and configured to perform adjustment of a backrest angle of the seatback 2 and adjustment of a sitting position of the seat cushion 3 by electric motor operations of switches.

More specifically, the seatback 2 is configured such that lower ends of right and left sides thereof are connected to rear ends of right and left sides of the seat cushion 3 via electrically-driven recliners (not shown), respectively. This maintains the seatback 2 in a state where its backrest angle is regularly fixed by the respective recliners, and when the respective recliners are electrically operated by operating a switch (not shown), the backrest angle is adjusted in a front-rear direction. Further, the seat cushion 3 is connected to a floor of a vehicle via a pair of right and left electrically-driven slide rails 4. Hereby, the seat cushion 3 is regularly maintained in a state where its sitting position is fixed by the respective slide rails 4, and when the respective slide rails 4 are electrically operated by operating a switch (not shown), the sitting position is adjusted in the front-rear direction.

Further, the seat cushion 3 is configured such that an electrically-driven seat lifter 5 is provided between the seat cushion 3 and each of the pair of right and left slide rails 4. Hereby, the seat cushion 3 is regularly maintained in a state where its sitting height position is fixed by the seat lifters 5, and when the seat lifters 5 are electrically operated by operating a switch (not shown), the sitting height position is adjusted in an up-down direction. Further, the seat cushion 3 includes an electrically-driven tilt mechanism 6 provided in a front part thereof. Hereby, the seat cushion 3 is regularly maintained in a state where a support angle of the front part thereof that supports a femoral region of the sitting occupant is fixed by the tilt mechanism 6, and when the tilt mechanism 6 is electrically operated by operating a switch (not shown), the support angle is adjusted in a height direction.

As such, the seat 1 is configured to perform a so-called “8-way” adjustment in which an adjustment operation is performable in eight directions, that is, the adjustment of the backrest angle of the seatback 2 (in two directions of front and rear directions), the adjustment of the sitting position of the seat cushion 3 (in two directions of front and rear directions and two directions of up and down directions), and the adjustment of the support angle of the front part of the seat cushion 3 (in two directions of up and down directions). These adjustment operations are performed by electric motor operations by operating switches (not shown) provided in a predetermined part such as a side portion on a vehicle width direction outside (a right side in the figure) of the seat cushion 3.

Further, in the seat 1 of the present embodiment, that front part of the seat cushion 3 which supports the femoral region of the sitting occupant is provided with an air bag unit 30 configured to prevent the sitting occupant from slipping in by expanding and deploying an air bag at the time of a front part collision of the vehicle, and an intake ventilator 20 configured to perform ventilation so as to prevent heat due to sitting on the seat cushion 3. The air bag unit 30 is set from above into a recessed portion 12D on that front panel 12 of the seat cushion 3 which performs an elevation operation by the tilt mechanism 6, and its lower side is fastened by bolts so that the air bag unit 30 is provided in an integrally fixed state.

Since the air bag unit 30 is set in the recessed portion 12D of the front panel 12 and its lower side is fastened by bolts, it is difficult to provide the ventilator 20 in a bottom portion of the front panel 12 by fastening it by bolts similarly to the air bag unit 30 in terms of space. In view of this, the ventilator 20 is provided across the front panel 12 and a front rod 5C provided behind the front panel 12 across both side frames 11 of the seat cushion 3. As such, the ventilator 20 is provided across the front panel 12 that performs an elevation operation in the height direction and the front rod 5C that does not perform an elevation operation, and a disposition position of the ventilator 20 is changed due to the elevation operation of the front panel 12. However, as will be described later, the ventilator 20 is attached between the front panel 12 and the front rod 5C so that the ventilator 20 is movable to follow the movement of the front panel 12 appropriately, so as not to disturb the elevation operation (a tilting operation) of the front panel 12. Hereby, even if a space where the ventilator 20 is integrally attached to the front panel 12 so as to be fixed thereto cannot be secured, it is possible to provide the ventilator 20 in a state where the ventilator 20 is attached to the seat cushion 3 appropriately. Here, the front rod 5C is an example of a “rod” in the present invention. The following describes a specific mounting structure of the ventilator 20 as well as a concrete configuration of the seat cushion 3.

As illustrated in FIGS. 1 to 3, the seat cushion 3 is configured such that a metal cushion frame 10 forming its framework is formed in a square frame shape along an outer circumferential shape of the seat cushion 3. More specifically, the cushion frame 10 includes: a pair of right and left side frames 11; and a front panel 12 provided across front ends of the respective side frames 11 so as to support the femoral region of the sitting occupant from below. The front rod 5C and a rear rod 5D each made of a metal circular pipe are assembled between the side frames 11 so as to penetrate therethrough in a shaft connecting manner in a seat-width direction. Hereby, the entire cushion frame 10 is configured to have a square frame shape in a plane view. Note that, a cushion pad (not shown) made of urethane foam and configured to receive a load of the sitting occupant by moderating the load, and a fabric cushion cover (not shown) covering up a whole surface of the seat cushion 3 from its outer peripheral side are attached to an upper part of the cushion frame 10. However, descriptions on concrete configurations thereof are omitted herein.

The side frames 11 are each formed of a single pressed steel sheet material, and cut so as to have a plate shape elongated in the front-rear direction. The side frames 11 are disposed so that their respective surfaces opposed to each other face a seat inner side. Each of the side frames 11 is configured such that an upper edge portion and a lower edge portion are bent toward a seat outer side, so that its structural strength to bending and torsion is increased.

Similarly to the side frames 11 described above, the front panel 12 is formed of a single pressed steel sheet material, and cut so as to have a plate shape elongated in the seat-width direction. The front panel 12 is disposed so that its surface faces a seat upper side. The front panel 12 is configured such that its front edge and right and left edges are bent toward a seat lower side so that its structural strength to bending and torsion is increased. Further, the front panel 12 is configured to have a shape in which its edge is not raised toward the seat upward side on which the occupant sits and toward its outer peripheral side. Further, in an upside central part of the front panel 12, the recessed portion 12D in which to incorporate the air bag unit 30 is formed in a shape hollowed in an elongated manner in the seat-width direction. Each of the right and left side portions of the front panel 12 is rotatably assembled, by a rotating shaft 12B (pin), to an intermediate portion of each of the side frames 11 in the front-rear direction in a shaft connected manner via an elongated tilt panel 12A extending toward the seat rear side.

The tilt panels 12A are each formed of a single pressed steel sheet material, and cut so as to have a plate shape elongated in the front-rear direction. The tilt panels 12A are each provided so that its surface overlaps with an inner side surface of each of the side frames 11. The tilt panels 12A are each configured such that an upper edge portion is bent toward the seat outer side, so that its structural strength to bending and torsion is increased. The tilt panels 12A are integrally fastened to right and left side edge portions of the front panel 12 by rivets provided on respective lower sides thereof so that their top. plate portions thus bent are placed right above those upper edge portions of the respective side frames 11 which are bent toward the seat outer side.

Respective rear ends of the tilt panels 12A are rotatably connected to intermediate portions of the respective side frames 11 by respective rotating shafts 12B (pins) in a shaft connected manner. The rotating shafts 12B are provided side by side on a coaxial line. Hereby, the front panel 12 is provided in a state where the front panel 12 is rotationally movable in the up-down direction relative to the respective side frames 11 around the respective rotating shafts 12B. Thus, the tilt mechanism 6 is configured to adjust the support angle for supporting the femoral region of the sitting occupant in the height direction by changing the support angle of the front panel 12 in the height direction.

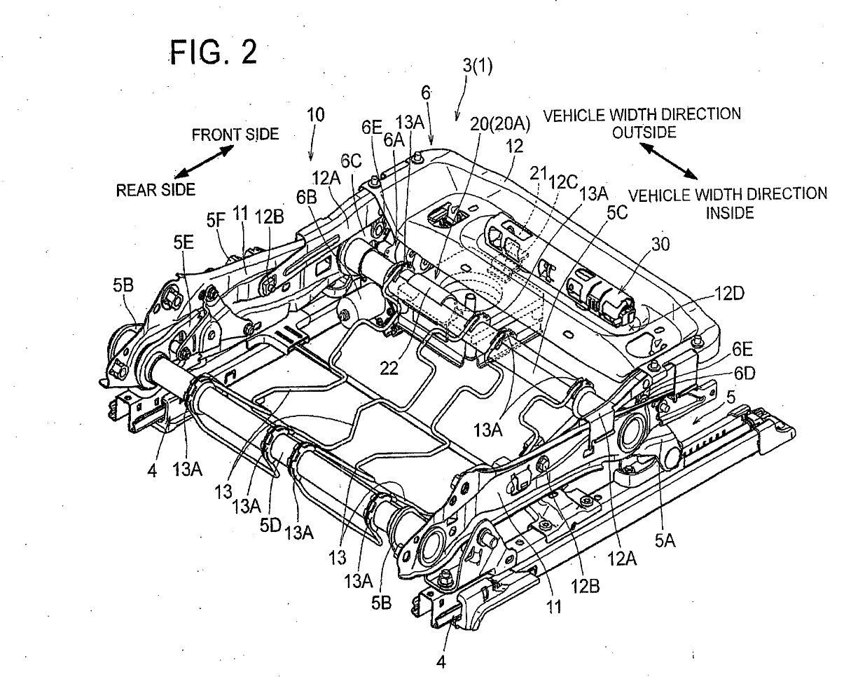

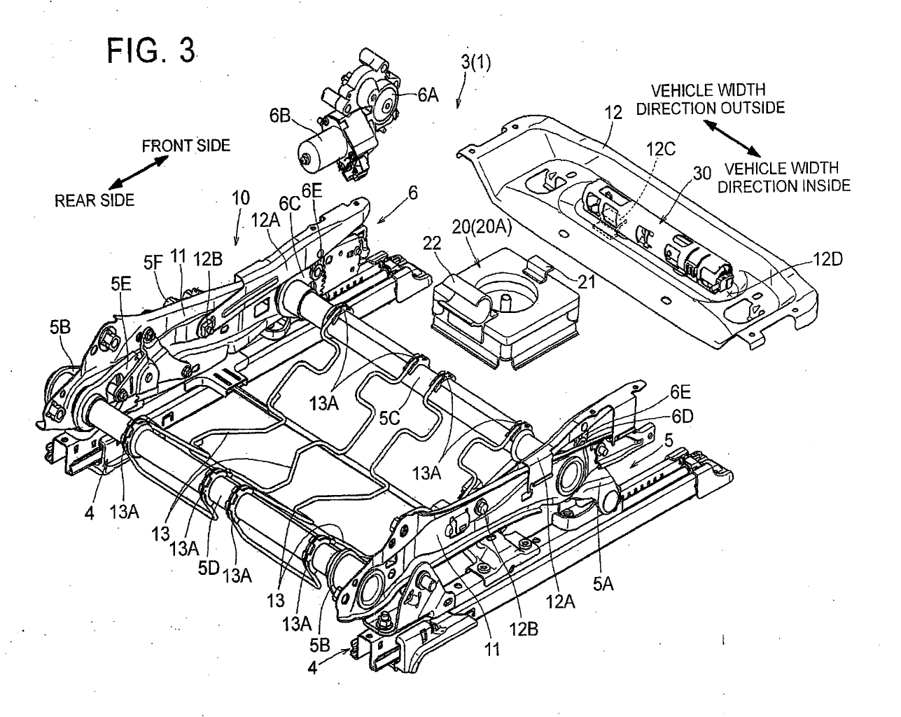

A tilt-up operation and a tilt-down operation to rotationally move the front panel 12 in the height direction is performed by driving of a driving device 6A provided on an inner portion of the side frame 11 on the vehicle width direction outside (illustrated on the left side of FIG. 2). As illustrated in FIG. 3, the driving device 6A transmits a power output from a drive motor 6B to a sector gear 6C integrally connected to a connection portion between the front rod 5C and the side frame 11 provided on the vehicle width direction outside, so as to rotate the sector gear 6C in the up-down direction around the front rod 5C. Hereby, the tilt panel 12A connected to the sector gear 6C via an intermediate link 6E is pushed up or down, thereby tilting up or down the front panel 12.

The sector gear 6C is integrally connected to the front rod 5C. When the sector gear 6C is rotationally driven, an arm 6D integrally connected to a connection portion between the front rod 5C and the side frame 11 provided on a vehicle width direction inside (on the left side in FIG. 1) is rotated together, so that the tilt panel 12A connected to the arm 6D via an intermediate link 6E is pushed up or down together. Thus, the tilt mechanism 6 is configured such that, the right and left tilt panels 12A are driven in the height direction at the same time, so as to move up and down the front panel 12, or to maintain a height position of the front panel 12. More specifically, the tilt mechanism 6 is configured such that the sector gear 6C that moves up and, down the tilt panel 12A provided on the vehicle width direction inside is integrally connected, via the front rod 5C, to the arm 6D that moves up and down the tilt panel 12A provided on the vehicle width direction outside. Accordingly, due to a force to cause the sector gear 6C on the vehicle width direction inside to stop rotating or to be rotationally driven by a force of the driving device 6A, the arm 6D on the vehicle width direction outside also stops rotating or is rotationally driven in an integrated manner. Hereby, the tilt mechanism 6 yields high support rigidity (torsional rigidity and flexural rigidity) that causes the respective tilt panels 12A to be supported or lifted up from below at the same time.

Next will be described a configuration of the seat lifter 5. The seat lifter 5 includes: a pair of right and left front links 5A; a pair of right and left rear links 5B; the front rod 5C configured to connect respective upper ends of the front links 5A to the respective side frames 11 of the seat cushion 3 in a rotatable manner; the rear rod 5D configured to connect respective upper ends of the rear links 5B to the respective side frames 11 of the seat cushion 3 in a rotatable manner; and a gear mechanism SE configured to transmit a rotational driving force and a brake force to the rear link 5B on the vehicle width direction outside.

The front links 5A are configured such that: the front link 5A on the vehicle width direction outside (illustrated on the right side of FIG. 1) is placed on an outer side (a seat outer side) of the side frame 11 on the same side; and the front link SA on the vehicle width direction inside (illustrated on the left side of FIG. 1) is placed on an inner side (a seat inner side) of the side frame 11 on the same side. The front rod 5C is inserted into the front links 5A in an axially rotatable manner so as to penetrate through the front links 5A and the side frames 11. Thus, the front links 5A are pivotally mounted to the respective side frames 11 via the front rod 5C in an axially rotatable manner. Note that, the front rod 5C is also pivotally mounted to the side frames 11 in an axially rotatable manner. Lower ends of the respective front links 5A are connected to upper parts of the respective slide rails 4 serving as a floor-side member, in an axially rotatable manner.

Similarly to the above, the rear links 5B are configured such that: the rear link 5B on the vehicle width direction outside (illustrated on the right side of FIG. 1) is placed on the outer side (the seat outer side) of the side frame 11 on the same side; and the rear link 5B on the vehicle width direction inside (illustrated on the left side of FIG. 1) is placed on the inner side (the seat inner side) of the side frame 11 on the same side. The rear rod 5D having a circular pipe shape is inserted into the rear links 5B so as to penetrate through the rear links 5B and the side frames 11, and the rear links 5B are integrally welded to the rear rod 5D so as to be connected thereto. Hereby, the respective rear links 5B are connected to the respective side frames 11 in an axially rotatable manner integrally with the rear rod 5D. Lower ends of the respective rear links 5B are connected to the upper parts of the respective slide rails 4 serving as a floor-side member, in an axially rotatable manner.

The gear mechanism 5E including a driving device 5F configured to transmit a power to cause the rear link 5B on the vehicle width direction outside (on the right side in FIG. 1 and on the left side in FIG. 2) to be rotationally driven or to stop rotating is connected to the rear link 5B. The seat lifter 5 is configured such that, when the front links 5A and the rear links 5B rotate in a swinging manner in the front-rear direction or stop rotating at the same time due to the driving force or the brake force transmitted from the gear mechanism 5E to the rear link 5B on the vehicle width direction outside, the seat lifter 5 adjusts a sitting height of the seat cushion 3 and maintains the seat cushion 3 in a position thus adjusted

At this time, the seat lifter 5 is configured such that the rear links 5B are integrally connected to each other via the rear rod 5D. Accordingly, due to a force to cause the rear link 5B on the vehicle width direction outside to stop rotating or to be rotationally driven, the rear link 5B on the vehicle width direction inside also yields high support rigidity (torsional rigidity and flexural rigidity) that causes the side frame 11 on the same side to be supported or lifted up from below.

The slide rails 4 are configured such that a space between mounting areas thereof in the seat-width direction is wide as follows: the slide rail 4 disposed on the vehicle width direction inside (illustrated on the left side of FIG. 1) is placed right under the side frame 11 on the same side; and the slide rail 4 disposed on the vehicle width direction outside (illustrated on the right side of FIG. 1) is placed in a position protruding outwardly (on the seat outer side) from the side frame 11 on the same side.

However, the front link 5A and the rear link 5B on the vehicle width direction outside are configured to be placed on the outer side (the seat outer side) relative to the side frame 11 on the same side so as to be connected to extended parts of the front rod 5C and the rear rod 5D penetrating through the side frame 11 on the same side. Accordingly, even in such a configuration in which the space between the respective mounting areas of the slide rails 4 in the width direction is wider than a space between respective mounting areas of the side frames 11 in the width direction, it is possible to easily assemble the front link 5A and the rear link 5B between the side frame 11 and the slide rail 4 having such a difference in dimension without adding other components such as a bracket for compensating the difference in dimension in the seat-width direction between the side frame 11 and the slide rail 4 on the same side.

Here, four metal support springs 13 (S springs) configured to widely elastically receive, from below, that load of the sitting occupant which is applied to a cushion pad (not shown) of the seat cushion 3 are provided across the front rod 5C and the rear rod 5D in the front-rear direction so that they are arranged side by side in the width direction. Each of, the support springs 13 is formed in a shape bent in a wave form in the seat-width direction, and configured such that front and rear ends thereof are hooked to the front rod 5C and the rear rod 5D-from above via respective resin caps 13A so that the each of the support springs 13 is mounted thereon. Hereby, even if the front rod 5C and the rear rod 5D axially rotate due to the operations of the tilt mechanism 6 and the seat lifter 5, the support springs 13 do not follow the movements of the front rod 5C and the rear rod 5D thus axially rotating, but the support springs 13 relieve the movements so that the support springs 13 are regularly maintained in a tensioned state with a constant posture between the front rod 5C and the rear rod 5D.

As illustrated in FIGS. 2 to 3, the ventilator 20 is provided across the front panel 12 and the front rod 5C in the cushion frame 10, so as not to disturb the tilting operation of the front panel 12. More specifically, the ventilator 20 is disposed in an intermediate position of the cushion frame 10 in the width direction, and a hook 21 formed in a front part of a top surface thereof is inserted into to a rear side of a bracket 12C connected to a bottom face portion of the front panel 12 and hooked thereto in a slidable manner. Further, a fitting portion 22 formed in a rear part of the top surface of the ventilator 20 is fitted to a front side of an outer peripheral portion of the front rod 5C so that the ventilator 20 is mounted thereto in a rotatable manner.

The hook 21 formed in the front part of the ventilator 20 has a plate shape that is bent in a crank shape so as to extend from the front part of the top surface of the ventilator 20 toward a seat front side. Similarly to the hook 21, the bracket 12C is bent in a crank shape and connected to the bottom face portion of the front panel 12. The hook 21 is inserted into the rear side of the bracket 12C so as to be hooked to that part of the bracket 12C that extends toward the seat rear side. Thus, the hook 21 is assembled to the bracket 12C with a lap margin (a slide margin) in which the hook 21. is slidable relative to the bracket 12C in the front-rear direction, so that a hook angle therebetween is changeable in the height direction.

Further, the fitting portion 22 is formed so as to project in a C-shape toward the seat rear side from the rear part of the top surface of the ventilator 20. When an opening of the C shape is pushed into the outer peripheral portion of the front rod 5C from outside in a radial direction, the C shape is pushed open elastically due to a shape of the outer peripheral portion of the front rod 5C, thereby fitting the fitting portion 22 into the outer peripheral portion of the front rod 5C. Thus, the fitting portion 22 is mounted to the front rod 5C in a rotatable manner. Due to such fitting, the fitting portion 22 is fitted into the outer peripheral portion of the front rod 5C in a state where the fitting portion 22 abuts with a surface of at least half of a region of the outer peripheral portion of the front rod 5C in its circumferential direction. Accordingly, while the fitting portion 22 is rotatable smoothly relative to the front rod 5C, the fitting portion 22 can yield a strong elastic force that prevents the fitting portion 22 from falling out of the front rod 5C.

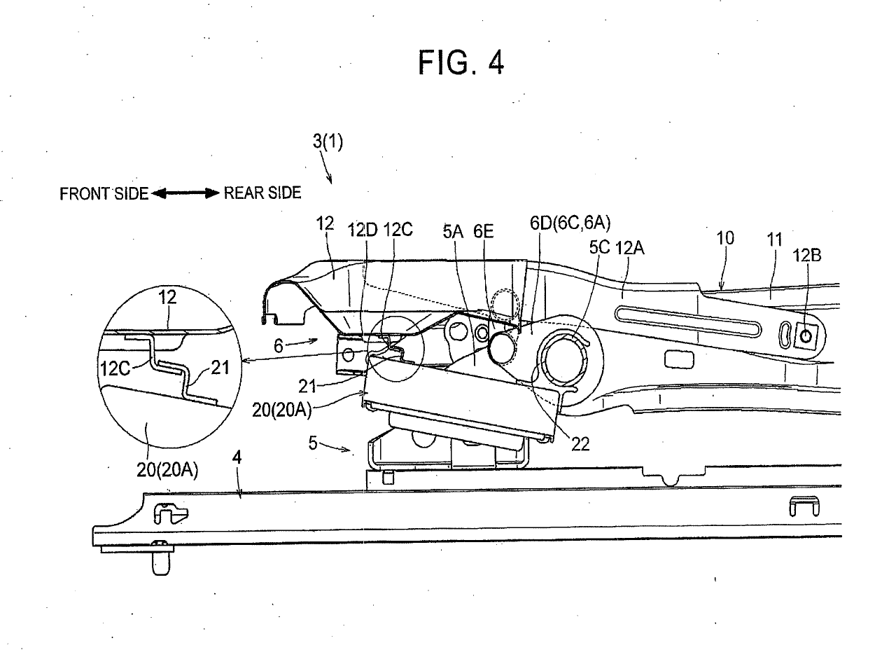

The ventilator 20 attached as such is configured as follows: when the front panel 12 is tilted up or down as illustrated, in FIGS. 4 to 6, the hook 21 provided on the front part thereof is slid in the front-rear direction relative to the bracket 12C connected to the bottom portion of the front panel 12, and the hook 21 on the front side and the fitting portion 22 on the rear side are rotated relative to the bracket 12C and to the front rod 5C, respectively, so that the ventilator 20 follows a movement of the front panel 12. Hereby, even if the ventilator 20 is configured to rotate around a center (the front rod 5C) that is different from a rotation center (the rotating shaft 12B) of the front panel 12, the ventilator 20 is movable appropriately in conjunction with the movement of the front panel 12 without disturbing the elevation operation of the front panel 12.

Note that the ventilator 20 has the following well-known configuration. That is, a rubber duct (not shown) is attached to an inlet port on the top surface of the ventilator 20, so that the ventilator 20 is connected to a connection opening of an air distribution groove formed in a bottom face portion of the cushion pad (not shown). Hereby, the ventilator 20 has a ventilation function to ventilate the cushion pad by taking in air from a vent hole penetrating from the air distribution groove to a top plate of the cushion pad. Accordingly, even if the ventilator 20 is tilted in the front-rear direction due to the elevation operation of the front panel 12, the rubber duct is bent so as not to affect the ventilation function.

Further, the hook 21 and the fitting portion 22 formed in the ventilator 20 are configured as resin components integrally molded in a case portion 20A made of resin and constituting a housing of the ventilator 20. As such, since the fitting portion 22 is made of resin, the contact thereof with respect to the metal front rod 5C is not contact between metals, thereby hardly causing abnormal noise such as rattle noise along with shaking of vehicle or sliding noise at the time of relative rotation, between the ventilator 20 and the front rod 5C. Further, the contact of the fitting portion 22 with respect to the bracket 12C provided on the bottom face portion of the front panel 12 is not contact between metals, thereby hardly causing rattle noise along with shaking of vehicle or abnormal noise in sliding, between the ventilator 20 and the bracket 12C. Note that the hook 21 and the fitting portion 22 may be made of a metallic component. However, in order to moderate the contact thereof with respect to the metal bracket 12C and the front rod 5C, it is preferable to provide a cushioning material having a good slidability, such as a resin coating, on contact faces to the bracket 12C and to the front rod 5C.

Thus, the seat 1 of the present embodiment includes the cushion frame 10 (a seat frame) and the ventilator 20 (an attachment device) attached to the cushion frame 10. The cushion frame 10 includes the front panel 12 and the front rod 5C (two members) rotating relative to each other around respective shafts parallel to each other. The seat 1 has a connection structure in which the ventilator 20 is connected to the front panel 12 (one of the two members) and the front rod 5C (the other of the two members) so as to be rotated in conjunction with relative rotation therebetween.

With such a configuration, it is possible to move the ventilator 20 appropriately in conjunction with the relative rotation between the front panel 42 and the front rod 5C. As such, it is possible to attach the ventilator 20 between the front panel 12 and the front rod 5C that rotate relative to each other, so that the ventilator 20 follows the relative rotation appropriately.

Further, the front panel 12 and the front rod 5C are configured such that a radial distance therebetween is changed due to their relative rotation. A connecting structure (at least one connecting structure) between the ventilator 20 and the front panel 12 is provided with a relief structure that is able to relieve that radial displacement of a connection position thereof which is caused due to the relative rotation (a structure in which the hook 21 is attached to the bracket 12C in a slidable manner in the front-rear direction). Due to the relief structure, it is possible to move the ventilator 20 appropriately in conjunction with the relative rotation between the two members while relieving that radial displacement of the connecting position which is caused due to the relative rotation.

Further, the ventilator 20 is hooked to one of the two members (the front panel 12) with the relief structure that is rotatable and radially slidable, while the ventilator 20 is attached to the other of the two members (the front rod 5C) in a rotatable manner. With such a simple configuration in which the ventilator 20 is hooked to the one of the two members (the front panel 12) and is attached to the other (the front rod 5C) in a rotatable manner, it is possible to attach the ventilator 20 between relatively rotatable members of the cushion frame 10, appropriately in conjunction therewith. More specifically, with the use of a structure to fit the ventilator 20 into the circular pipe-shaped front rod 5C from its outer peripheral side, and a structure to hook the ventilator 20 to the bracket 12C provided in the bottom portion of the front panel 12, it is possible to easily assemble the ventilator 20 so as not to disturb the tilting operation of the front panel 12 of the seat cushion 3 (in such a manner that the ventilator 20 follows the tilting operation appropriately).

The embodiment of the present invention has been described above with reference to one example, but the present invention can be performed in various embodiments other than the above example. For example, the “conveyance seat” of the present invention is applicable to seats other than the front left seat of the automobile. Further, the vehicle seat of the present invention is widely applicable to seats used in a vehicle other than the automobile, such as a train car, and other conveyances such as an aircraft, a ship, and the like.

Further, the configuration of the present invention is widely applicable to a structure in which an attachment device is attached to a seat frame including two members rotating relative to each other around their respective shafts parallel to each other, and is also applicable to a configuration in which a radial distance between two members does not change even if the two members rotate relative to each other. Further, the configuration of the present invention is applicable to those configurations of various seat frames including two members rotating relative to each other which are applied to a conveyance seat. More specifically, the configuration of the present invention is applicable to, for example, a deployment mechanism of an ottoman provided in a front part of a seat cushion, a center-foldable mechanism provided in a seatback, and the like.

Further, the “relief structure” of the present invention should be applied to at least one of connecting structures configured to connect the attachment device to two members rotating relative to each other. In Embodiment 1, the connection between the ventilator 20 (the attachment device) and the front panel 12 (one of the two members) may be set as a rotatable connection, and the connection between the ventilator 20 (the attachment device) and the front rod 5C (the other of the two members) may be set as a connection having the relief structure that is rotatable and radially slidable. Further, the “attachment device” of the present invention may be attachment devices other than the ventilator and may be an attachment device such as an ECU to be assembled to a seat (in a state where the attachment device moves together with the seat).

What is claimed is:

1. A conveyance seat comprising:
a seat frame; and
an attachment device attached to the seat frame, wherein:
the seat frame includes two members rotating relative to each other around their respective shafts parallel to each other, and respective connecting structures configured to connect the attachment device to one of the two members and to the other of the two members in such a manner that the attachment device is rotated in conjunction with the relative rotation between the two members.

2. The conveyance seat according to claim 1, wherein:
the two members are configured such that a radial distance therebetween is changed due to their relative rotation; and
at least one of the connecting structures is provided with a relief structure that is able to relieve that radial displacement of a connection position which is caused due to the relative rotation between the two members.

3. The conveyance seat according to claim 2, wherein:
the attachment device is hooked to the one of the two members with the relief structure that is rotatable and radially slidable, while the attachment device is attached to the other of the two members in a rotatable manner.

4. The conveyance seat according to claim 3, wherein:
the other of the two members is a circular pipe-shaped rod provided across both side frames of a seat cushion;
the one of the two members is a front panel provided across the both side frames so as to be pivotally mounted thereto in a rotatable manner in a height direction; and
the attachment device is a ventilator hooked to a bracket provided in a bottom portion of the front panel so as to be rotatable and slidable in a front-rear direction, and fitted into the rod from an outer peripheral side thereof in a rotatable manner.
